(19) United States
(12) Patent Application Publication
(10) Pub. No.: US 2017/0132711 A1
(43) Pub. Date: May 11, 2017

(54) SEQUENTIAL ESTIMATE AUTOMATION

(71) Applicant: ACCURENCE, INC., Westminster, CO (US)

(72) Inventors: Timothy Bruffey, Commerce City, CO (US); Zachary Labrie, Broomfield, CO (US)

(73) Assignee: ACCURENCE, INC., Westminster, CO (US)

(21) Appl. No.: 15/345,071

(22) Filed: Nov. 7, 2016

Related U.S. Application Data
(60) Provisional application No. 62/251,536, filed on Nov. 5, 2015.

(51) Int. Cl. G06Q 40/08; G06Q 10/00

(52) U.S. Cl. CPC G06Q 40/08; G06Q 10/20

(57) ABSTRACT

Methods and systems for sequential estimate automation are described, wherein data extracted from an initial estimate is analyzed using a database of rules and a database of previous estimate data. Mitigation estimates or other information provided to the method or system may be supplemented through the use of intelligent decisions. Results of the methods and systems may be used to automatically generate a scope of work estimate.

### RELATED APPLICATION DATA

This application claims the benefit under 35 U.S.C. §119(e) of U.S. Provisional Patent Application No. 62/251,536, filed on Nov. 5, 2015, and entitled “SEQUENTIAL ESTIMATE AUTOMATION,” which is incorporated herein by reference in its entirety.

### TECHNICAL FIELD

An exemplary embodiment relates generally to mitigation estimate generation methods and systems, and more particularly to a method for automatically generating accurate estimates of damage to physical locations using past estimate data to at least increase the efficiency, accuracy and cost-effectiveness of calculating and estimating such damage.

### BACKGROUND

Homes and commercial buildings may experience damage or otherwise be negatively impacted due to fires, earthquakes, tornados, flooding, and other disasters. Such disasters may be of natural causes, or they may result from mechanical failure, human error, or any number of other non-natural causes. As an example, flooding may result from a wide variety of natural conditions, including excessive rain, storm surges, or rapid melting of snow or ice. Additionally, freezing temperatures may cause the water inside water pipes to freeze, expand and burst the pipes. Water hoses may be become disconnected, or may become brittle and break. Sinks and commodes may overflow from clogged pipes. As another example, fire can result from natural causes, such as lightning strikes, or it can result from human-related causes, such as a gas leak resulting in gas buildup, ignition and “puff back”; a stove or oven that becomes excessively hot; an overloaded electrical circuit; or a curling iron left in close proximity to a flammable material. The cause of damage to property may come from any number of sources and the damage caused to the property typically varies greatly with each and every cause in any number of ways related to the scope and magnitude of the damage.

The damage caused by water, fire, or other disasters is rarely easy to identify, or even limited to the area where the mishap occurred. A pipe, for example, may suffer a break that is confined to a particular location, but broken pipes often lead to flooding, which may be widespread throughout an entire structure and the scope of such flooding may be impossible to determine during simple inspection. Likewise, even though a fire may be contained to a particular room or location in a building, it may cause smoke damage throughout the entire building or even adjacent buildings in places not easily accessible. Moreover, the building may suffer water damage and/or other types of damage as a result of efforts to extinguish the fire. Such damage may affect the structure of a property in ways that are impossible to determine without extensive testing or, in some cases, actual demolition of the property.

In these and similar situations, the affected properties require mitigation, through which the structure of the property is returned to a build-ready state. Mitigation is the process of bringing a damaged property to a “build-ready” state, i.e. repairs to the structure or other repairs so that the reconstruction process may begin. This may involve extracting water, cleaning surfaces, installing equipment (e.g. dehumidifiers, fans, sump pumps, and so forth) and any number of other activities completed by mitigation companies. Once the property has been returned to a build-ready state, reconstruction can commence, including the installation of new flooring materials, wall coverings, and so forth. Ideally, once a build-out is completed, the property will have been restored to pre-loss conditions. As used herein, a mitigation estimate is a price estimate focused on the cost of returning a structure on a property to a dry standard such that it is ready for reconstruction, which may include line items for one or more of, by way of non-limiting example: demolition; drying of structure; odor control; cleaning; remediation techniques; and tarping, heating, etc. to protect against secondary damages. A construction, repair, or reconstruction estimate is an estimate focused on the cost of returning the structure of the property to a pre-loss condition ready for use by the property owner, and may include line items for one or more of, by way of non-limiting example: drywall, paint, floor coverings, fixtures, reinstallation of appliances, tile work, finishing, and so forth.

When a damaged structure is insured, the first step in disaster mitigation and restoration often involves notifying the insurance company of the damage or loss. The insurance company then typically dispatches a person, e.g. a vendor or adjuster, to personally visit the damaged location to assess the loss and write an initial mitigation estimate that addresses the initial loss and any secondary damages. Alternatively, the insured party may call a vendor directly, personally provide a description of the damage to receive an initial mitigation estimate from the vendor, and then contact the insurance company. The initial mitigation estimate is truly an estimate, as the full scope of activities needed to return a property to a build-ready state often cannot be completely accurately determined until after mitigation work has begun. The full extent of water damage, for example, may not be visible without removing drywall, flooring, and other surfaces to gain access to the structure beneath. Also, as mitigation work progresses, additional damage may occur or be discovered. For example, materials may not become dry quickly enough to prevent mold growth. Water may not release from wood floors quickly enough, which may cause binding and cupping of the wood floor. The scent of smoke may require additional coats of sealant or paint. As a result, overall salvage-ability of the structure may not be determined or determinable initially, before cleaning is attempted, or before damage not initially visible as well as secondary damage is identified. Only after the full scope of necessary mitigation work is defined and completed, can a final invoice be generated and sent to the insurance company by the adjuster or vendor for the mitigation services rendered. At this point, the insurance company may dispatch a second adjuster or vendor to assess the rebuild of the property from a build-ready state through to the final restoration to the property's pre-loss condition. This assessment is described as a restoration estimate. There is less variability in the restoration estimate, because the mitigation work leaves the property in a normalized condition.

Sometimes, an initial reconstruction estimate is first prepared, and then used to generate a mitigation estimate. As described above, additional information may be uncovered during the course of mitigation that necessitates changes to the initial reconstruction estimate. Because of this, an accurate and timely mitigation estimate is an extremely desirable tool for any insurance company and is an elusive goal due to the variability of and the difficulty in generating a mitigation estimate.

### SUMMARY

The mitigation and restoration process described in general terms above is complicated, and the level of complexity has been increasing over the last two decades as building science, building materials, government regulation, restoration processes and technology as well as insurance provisions evolve and grow more complex. Due to the complexity, the breadth, and the uniqueness of each instance of damage, gathering the information required to generated an accurate estimate for the location is an extremely inefficient process. Moreover, much of the damage cannot be seen by the naked eye of an adjuster and may be discovered only late in the mitigation process. Even in the case of an adjuster with a great deal of experience and knowledge, the uniqueness of each damage instance makes it essentially impossible for an adjuster to gather the requisite information in an efficient manner without some aid from technology.

While an adjuster may be able to see a number of symptoms of an underlying cause of damage, the adjuster may be incapable or unlikely to discover the source or cause of the damage, or other issues affecting the mitigation estimate. Such issues may only be discovered with the aid of some technology. Without such technology, an adjuster cannot possibly be completely confident his estimate is as accurate as possible according to the most recent rule changes and according to the most recent other estimates in the field. Without some form of technological aid, an adjuster will fail to account for the most up-to-date rules and other information in making the initial mitigation estimate.

Technology is increasingly used for taking readings, documentation of damages, and general communication between the parties, of which there are many: homeowners, vendors, building inspectors, insurance agents, insurance adjusters, mitigation companies, restoration contractors, insurance carriers, quality assurance departments, government insurance programs (e.g. National Flood Insurance Program and Coastal Wind Plans, Citizens Property Insurance in Florida), etc. In the United States, the homeowner and commercial insurance industries help customers manage over one hundred billion dollars in severity annually. Those industries spend approximately forty-one billion dollars in operating expenses associated with such losses. Improving the accuracy and speed of estimate generation after a loss both helps property owners better understand the financial and temporal scope of needed work, and reduces operating expenses for contractors and carriers by reducing waste and allowing for more efficient allocation of resources. By having an accurate and timely estimate, an insurance company is enabled to have efficient cash flow underwriting which enables an insurance company to collect premiums and pay losses while investing premiums to earn a return in investment markets.

Various methods have been proposed for generating estimates in an efficient manner. Prior methods in this area have long suffered from the need of providing an economical means of generating such estimates due to the extremely laborious and lengthy processes involved with such prior traditional techniques. These shortcomings have significantly limited all prior estimate generation methods and apparatuses. Indeed, the limitations of cost, time required to produce an adequate estimate, and the inherent limitations of prior methods and apparatuses to satisfactorily provide a timely and accurate estimate, leave a significant gap in the potential of estimate generation methods and apparatuses in the state of the art.

The current practice for estimate generation is by manual techniques commonly using standardized forms and passive systems. In this practice, the generation of estimates is an inefficient and inaccurate system. Accordingly, to generate an accurate estimate, the adjuster needs to consult a wide number of sources which are often out of date by the time the adjuster visits the site of the damage.

The present disclosure overcomes many of the deficiencies of the prior art and obtains its objectives by providing an integrated method embodied in computer software for use with a computer for the rapid, efficient generation of estimates, thereby allowing for estimates to be produced in a very cost effective manner.

Accordingly, it is an object of this disclosure to provide a method for automatically determining the adequacy of the data gathered in support of an estimate. The system is integrated with computer means for analyzing the data, determining relevant rules, and applying said rules in an efficient manner. The method of the present disclosure further provides an extremely rapid and cost effective means to automatically aid in the workflow of adjusters and mitigation contractors in the generation of estimates.

Additional objects and advantages of the disclosure will be set forth in the description which follows, and in part will be obvious from the description, or may be learned by practice of the disclosure. The objects and advantages of the disclosure may be realized and obtained by means of the instrumentalities and combinations particularly pointed out in the appended claims.

### BRIEF DESCRIPTION OF THE DRAWINGS

The present disclosure is described in conjunction with the appended figures, which are not necessarily drawn to scale:

FIG. 1 is a functional block diagram illustrating a system comprising computer hardware enabled to execute a method in accordance with an exemplary embodiment of the disclosure.

FIG. 2 is a flowchart illustrating a method of receiving an estimate and generating an estimate through intelligent decisions with use of rules and data in accordance with an exemplary embodiment of the disclosure.

FIG. 3 is a flowchart illustrating a method of receiving submitted information and generating an estimate or supplementing the information in accordance with an exemplary embodiment of the disclosure.

FIG. 4A is a flowchart illustrating a method of generating an estimate provided supplemented data in accordance with an exemplary embodiment of the disclosure.

FIG. 4B is a flowchart illustrating a method of generating an estimate provided supplemented data in accordance with an exemplary embodiment of the disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Reference will now be made in detail to the present preferred embodiments as illustrated in the accompanying drawings.

In accordance with some embodiments of the present disclosure, information gathered from numerous mitigation and restoration efforts over time may be collected and stored in a database to be used in a system and method wherein inspection data and/or initial estimates are gathered from estimating companies and other vendors; one or more of a building science rule set, materials rule set, and carrier guideline set may be applied to the data; a scope of repair may be generated; and the job file may be intelligently documented. In this manner, actual results from past mitigation and restoration projects can be applied (through the application of one or more sets of rules) to develop an accurate scope of repair estimate that is not limited to visible damage, but also addresses expected damage based on the conditions of the structure at issue.

In accordance with other embodiments of the present disclosure, existing repair estimates can be analyzed and used to generate a mitigation estimate, or to audit an existing mitigation estimate. Alternatively, the repair estimate can be used to generate a competitive or audited repair estimate. In accordance with additional embodiments of the present disclosure, an existing mitigation estimate can be analyzed and used to generate a second mitigation estimate, or to audit the first. In still further embodiments of the present disclosure, a supplement (e.g. a secondary service and payment requests) can be reviewed to determine whether the supplement is within scope based on a mitigation or repair estimate.

By analyzing past inspection data and previous estimates, trends may be identified. These trends may be used to generate new rules. The rules and sets of rules discussed herein may be in the form of processor-executable instructions stored on a database accessible by a processor of the automated system. The rules may provide for efficient analysis of the initial mitigation estimate data and may enable the generation of a revised mitigation estimate. For example, a line item in an inputted estimate may on its own appear to be a standalone issue, but though the insight provided by past similar estimates, the line item may be a sign of a possible secondary issue. A rule may be created such that when a line item is included in the inputted data which has been shown to be a sign of another issue, the system must take such an issue into consideration in its mitigation estimate generation. This rule may be that the system will make an assumption as to the second issue, or on the other hand, the system may require new information regarding the second issue. If such new information is not included in the initially inputted data, the system may require the inspector to provide that data.

As more information is stored in the past mitigation estimate database, new rules may be generated. New rules may be based on trends in data wherein the system is enabled to determine a number of possible latent issues by analyzing the data input by the initial estimate submitter. The application of rules to the initial mitigation estimate may allow for a great increase in the efficiency of an onsite adjuster. An adjuster, by uploading an initial mitigation estimate from the damaged location is enabled to be confident in the accuracy of the mitigation estimate without spending an inefficient amount of time unnecessarily inspecting the damaged property.

After applying rules to the data, the system may determine additional information is required from the damaged location. For example, past mitigation estimate data may result in the generation of a rule wherein if a particular issue is included in the information inputted into the system, the system will determine if all of the required information to accurately generate a mitigation estimate for a property including such data is included in the initial information. If the system determines the initial data lacks any of the required additional information, the system is operable to collect the missing required additional information by generating a request for said missing required additional information. Such a request may take the form of a written question or a form containing a list of the required information. This request may be sent via a network to one of a desk mitigation estimate adjuster or the onsite adjuster who submitted the initial information.

Alternatively, the system may be enabled by a rule to make a number of assumptions and apply data from previous estimates based on issues included in the initially submitted data. This additional information added to the initially submitted data based on the assumptions made by the system may be data obtained from past estimates stored in the past estimates database. For example, by analyzing past estimates, trends may be detected. When a property is inspected that is similar to a number of previously inspected properties, an assumption may be made by the system to update the mitigation estimate.

According to one embodiment of the present disclosure, a system for automating the estimate process associated with mitigation and/or restoration work comprises a user interface (e.g. a graphical user interface, touchscreen, keyboard, mouse, or any combination of the foregoing that allows information to be entered into the system and reported by the system) and/or a communication transceiver (e.g. a wireless radio, a modem, an Ethernet card, or any other device for sending and receiving data), a processor, and a memory storing instructions for execution by the processor as well as mitigation estimate data. The instructions are configured to cause the processor to programmatically receive an initial mitigation estimate or inspection information via the user interface or communication transceiver; extract data from the initial mitigation estimate or the inspection information in a sorted and organized manner for processing; and analyze the extracted data to make intelligent decisions. Intelligent decisions may include any of the following, alone or in combination:

(a) Mapping mitigation or restoration line items to their mitigation or reconstruction counterparts, which may be represented in a one-to-many relationship, one-to-none, or a many-to-one relationship.

(b) Adjusting quantities in the mitigation estimate to building-material-specific quantities for reconstruction, or adjusting building-material specific quantities for reconstruction to quantities in the mitigation estimate, either of which may involve increasing or decreasing the material quantities or the quantities in the mitigation estimate, and/or using alternative materials.

(c) Defining the scope of repair items that do not require reconstruction components, or defining the scope of repair items that do not require mitigation components.

(d) Defining reconstruction items required that do not have a mitigation counterpart, but rather result from the reconstruction activities themselves.

(e) Identifying items for which further information is needed from a system, homeowner, vendor, end user, or another participant. Each of these items may be mapped either to a related question that can be understood by a subject matter expert (SME), or, alternatively, to a basic data request that can be completed by a layperson, or that a system can extract automatically from a photo, sketch, or caption. The basic data request, which a layperson may understand and complete, may identify an image, video, document, question, or other data point which ultimately manifests further needed information relating to the reconstruction scope or to general documentation of the property loss.

According to some embodiments, the method further involves iterating through letters (a)-(e) above until a minimum threshold is satisfied. The minimum threshold may be a minimum threshold for the amount of data required to generate an accurate scope of work statement. The minimum threshold may be based on a customer-configured level of accuracy for a particular situation, which may be driven by variables such as dollar impact, percentage of accuracy, percentage of dollars, number of activities, level of difficulty extracting additional items, etc. The minimum threshold may be the same for all estimates processed with the method, or it may be dependent on (or established by) the particular rule set used for the method. Once the minimum threshold is satisfied, line items for a scope-of-work statement are generated and configured in the contractor or insurance carrier profile within the system. The scope-of-work item list may then be passed through a set of applicable rules which may be configured specifically for a given insurance carrier, location, loss type, coverage plan, etc. This configured rule set then adjusts the scope by adding, removing, or otherwise manipulating the line items to include textual notes, quantities, activities, etc., after which the restoration build back estimate is finalized. In embodiments, the rule set may be developed based on the actual results of past mitigation and restoration activities. In further embodiments, the rule set compares the extracted data to stored data from past mitigation and restoration projects, and uses actual tasks and costs corresponding to the past mitigation and restoration projects to prepare a scope-of-work statement for the damaged structure in question. While contemporary methods of generating mitigation estimates involve an adjuster collecting all of the requisite information from the damaged location, the presently disclosed methods enable an adjuster to be more efficient in the initial inspection by saving time and not unnecessarily over-inspecting the property while obtaining a higher degree of accuracy in the initial mitigation estimate through the application of previous mitigation estimate data to the present mitigation estimate.

In embodiments, the configured rule set is used to generate a mitigation estimate. For example, in some circumstances, a repair estimate may be needed to substantiate a request for a full insurance payout. The configured rule set can be used in these circumstances to generate the needed repair estimate, thus saving the adjuster significant time and resources, especially if the adjuster lacks, or does not have access to, subject matter expertise in one or more loss areas.

The system also documents what decisions were made based on the rules configuration and situational intelligence that were applied. Reports, documents and file information may be generated, and can be integrated and stored in the appropriate place for the specific process.

As a final step in the process, or in separate embodiments, the system may rate the quality of a mitigation estimate and advise of rules associated with the activities performed by the mitigation vendor. This step or embodiment constitutes, in essence, a retrospective audit.

In embodiments, the system can repeat the process of programmatically receiving data from a mitigation estimate; extracting data in a sorted and organized manner for processing; and analyzing the resultant information to make intelligent decisions, based on multiple mitigation estimates being consumed as the process evolves and iterates from one step to the next. At each iteration, the system can predict and recommend a reserve for the claim (reserves are required by state insurance departments, and are associated with funds from premiums being set aside for potential losses to be paid). Having an accurate reserve enables efficient cash flow underwriting, which involves collecting premiums and paying losses while investing premiums to earn a return in investment markets.

In embodiments, the system also has a process for disqualifying the mitigation estimate or secondary supplement for the aforementioned process based on attributes of the estimate or other configuration requirements determined by customers utilizing the system.

The automated system may be software executed by one or more processors on a server or a personal computer or some other computing device. Additionally, the systems, methods and protocols can be implemented to improve one or more of a special purpose computer, a programmed microprocessor or microcontroller and peripheral integrated circuit element(s), an ASIC or other integrated circuit, a digital signal processor, a hardwired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various methods, protocols and techniques according to the disclosure provided herein.

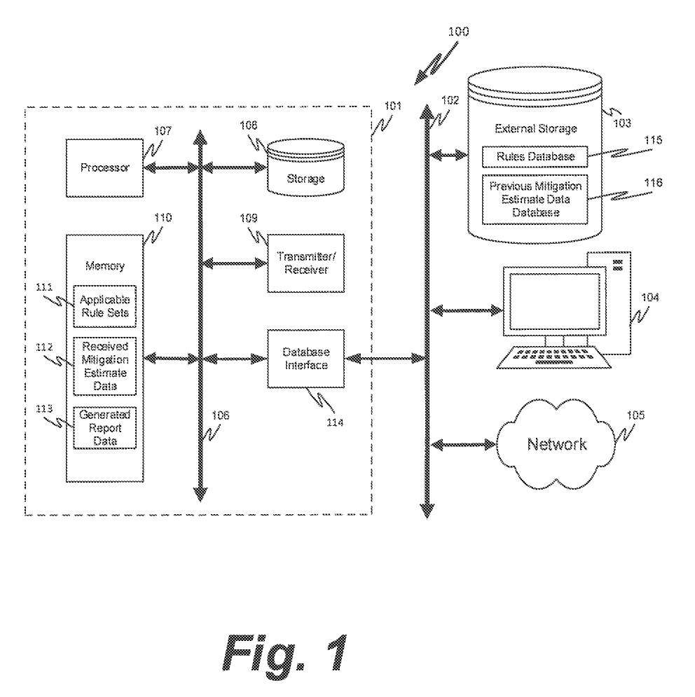

Embodiments disclosed herein may comprise one or more customer devices, a network, one or more servers, and one or more databases. An overview of an embodiment of the system is illustrated in FIG. 1.

In particular, a user of a client device 104 may operate and utilize the device 104 to enter a mitigation estimate and/or other inspection data, as discussed herein. The client device 104 may be in communication with a network 105 or directly in communication with a server 101 and an external storage device 103 via a communications link 102. Functions involved with performing steps of the embodiment may be performed within the server 101. Alternatively, the steps required for an embodiment of the system may be performed entirely within the user device 104.

An example environment comprising a server performing the steps of the system is illustrated in FIG. 1. Server processor 107 may comprise one or more microprocessors, controllers, or other computing devices or resources interconnected via one or more communication links. The processor may operate alone or in conjunction with other components or additional processor(s) of the system described herein.

Processor 107 may be communicatively coupled to memory 110 via an internal link 106. Memory 110 may take the form of volatile or non-volatile memory including, but not limited to, magnetic media, optical media, random access memory (RAM), read-only memory (ROM), removable media, or any other type of memory component. In some embodiments, memory 110 may be internal or external to the processor 107 and may include instructions to perform the steps of embodiments of the system. In some embodiments the server may further comprise a transmitter/receiver 109 used to communicate with external device, i.e. a client device 104, an external storage device 103 and/or a network 105 as well as an internal storage device 108. The memory 110 may be operable to store processor-executable instructions to instruct the processor to apply the rules discussed herein to the data. Initial mitigation estimate data 112 may be received from an adjuster using a user device via the receiver 109 and stored in the memory 110. Rules and rule sets determined to be applicable to the received mitigation estimate 112 may be stored in the memory 110 as applicable rule sets 111. Reports generated by the automated system may be stored in the memory 110 as generated report data 113.

The transmitter/receiver 109 may include any necessary hardware and/or software for sending data signals, control signals, etc. to and from external components and the processor 107. Example embodiments contemplate that the transmitter/receiver 109 may be configured as simple output/input ports or more complex transmitter/receiver circuits having drivers and other associated circuitry, such as circuitry for wireless communication. In some embodiments, the transmitter/receiver 109 are configured to transmit and receive, respectively, signals via wired communications to other elements either via a circuit trace (e.g., via a PCB), an IC trace (e.g., an electrical trace or via established in an IC chip), an external wire, or the like.

Embodiments of the present disclosure may be performed in such a system as illustrated in FIG. 1 in a number of ways. For example, the databases discussed herein may be stored on external storage 103 and/or accessed via the network 105. These databases may be accessed via a database interface 114 of the server 101. The database interface 114 may be operable to query and filter the information stored in the external storage 103 and associated databases. An initial mitigation estimate, or other assessment data, may be input into the server 101 via the client device 104. The iterative process disclosed herein may be performed, for example, by the processor 107 of the server 101, or via a processor of the client device 104. The initial mitigation estimate data may be stored temporarily in the memory 110, the storage 108, the external storage 103, or sent to the client device 104 or to a network location on the network 105. The processor 107 may be operable to access a rules database 115 and/or a previous mitigation estimate data database 116. The processor 107 may be operable to query the rules database and filter the rules database 115 to access a number of applicable rules. Applicable rules may be obtained by the processor 107 via the database interface 114 and stored in the memory 110. The previous mitigation estimate data database may be queried by the processor 107. The processor 107 may be operable to filter the previous mitigation estimate data to access relevant previous mitigation estimate data. Relevant previous mitigation estimate data may be copied from the previous mitigation estimate data database 116 and stored in memory 110 to be applied to the initial mitigation estimate. The databases discussed herein may be stored on external storage 103 and may be updated via the network 105, the client device 104, or via the transmitter/receiver 109.

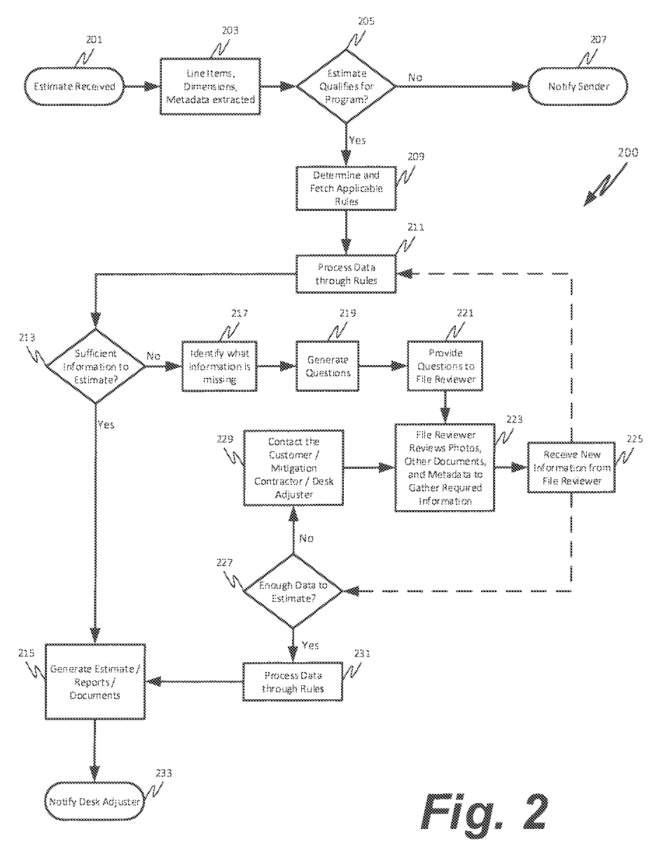

An exemplary embodiment of the process is illustrated in the flowchart of FIG. 2. As illustrated in FIG. 2, the process 200 begins when an estimate is received by the automated system in step 201. An insurance adjuster, or some other type of investigator, visits a damaged property to collect information. While in this exemplary embodiment an insurance adjuster visits the damaged property, alternatively an insured party, such as the owner of a damaged home, or any other person may perform the assessment. The person conducting the assessment should have some means of communications wherein information from the assessment of the damaged property may be input into the system.

In the exemplary embodiment, the insurance adjuster collects information pertaining to the damage. As discussed above, this assessment may be limited to the adjuster's field of view and personal knowledge and experience. An inexperienced adjuster will likely fail to identify a great deal of issues, and even the most experienced adjuster will likely fail to identify many latent defects which must be addressed during mitigation. These defects may only be discovered by workers following commencement of the mitigation process, too late to be included in the initial mitigation estimate. Using the system as disclosed herein, however, past estimate information and data related to previous mitigation efforts from other damaged properties may be used to discover such latent defects and to update and adjust the present initial mitigation estimate according to the most recent and most accurate information. Such an adjuster will be enabled to be entirely confident in the accuracy of the estimate.

Information gathered during the initial assessment of the damaged property may be entered into a user device, e.g. portable/mobile/cellphone, tablet, personal computer. Alternatively, information gathered during the initial assessment may be delivered to the system using any method of entering data, for example, the owner of the damaged property may call an insurance company and explain the damage over the phone.

The information gathered during the initial assessment may take the form of an initial estimate—an estimate which may be enhanced later by the system—or take the form of a series of photographs and written explanations. The information should be in some way entered into the automated system, for example in the exemplary embodiment, the information should be entered into the user device and uploaded via a network connection to a server.

In such embodiments, the initial estimate and/or any information collected during the initial assessment is received by the automated system. The initial estimate may comprise inspection data (e.g. observations about the condition and/or integrity of various portions of the damage structure, measurements, etc.).

For example, an adjuster uploading data into the automated system may input the information gathered during the inspection of the property into a digital form on a network connected user device. The form may comprise a number of line item fields associated with common issues related to the mitigation estimate. An adjuster may use such a form as a workflow for inspecting property. Upon entering data into each of the line item fields, an adjuster may complete the initial inspection and upload the form to the automated system via a network. This may, as discussed herein, be uploaded to the automated system as standardized forms, lists, or any type of data which may be readable by a processor.

At step 203, line items, dimensions, metadata and other information is extracted by the automated system, as discussed above. This information should be sent to the automated system in such a way that the data needed for the estimate generation may be extracted by a processor. The system is operable to extract line items, dimensions, metadata, and so forth from the received initial mitigation estimate or the inspection information in a sorted and organized manner for processing.

At step 205, based on this extracted information, the system determines whether the estimate qualifies for the program, i.e. whether the estimate or submitted information meets a minimum set of requirements needed for the system to properly prepare an estimate. The minimum set of requirements needed may depend on the applicable set of rules. For example, a mitigation estimate conducted for a particular insurance carrier may require a particular number of line items, or a number of specific line items which must be completed for a mitigation estimate to be generated.

Alternatively, the system may detect incorrect data has been included in the initial estimate. For example, line items may not meet a particular formatting requirement, a photograph included in the initial estimate may lack required metadata, or data inputted into a line item may be of a wrong type, such as a number in a text field. Other issues may be detected in the mitigation estimate, e.g. a contractor submitting the estimate data may not be approved to use the automated system.

If the submitted information or estimate does not meet that minimum set of requirements, then the process processed to step 207 in which the sender of the estimate is notified, and the process stops. In such a case, upon being notified that the submitted information or estimate failed to meet the minimum set of requirements, and thus failed to qualify for the program, the send should collect and submit additional information along with the originally submitted information in order to continue with the process.

If the estimate does qualify for the program, then the system moves to step 209 and determines an applicable set of rules associated with the received data. The applicable set of rules may comprise a rule set selected by the sender of the estimate; a rule set selected by a desk adjuster; a rule set selected by a contractor; a default rule set; or any other rule set. Selecting a rule set may involve choosing from one of a plurality of predefined rule sets, or it may involve selecting specific rules from among a plurality of predefined rules, or it may involve creating new rules, or it may involve any combination of the foregoing. A number of rule sets may apply to a given estimate.

Rules may be stored on an external storage device accessible by the system. The rules may be stored on a database such that the rules may be sorted and filtered or grouped as collections of rule sets. The rules may be processor-executable instructions listed in a table and comprise tags identifying the rules. As the system determines the rules to apply to the data, the rules may be accessed from the database and stored in local memory. If a number of different sets of rules are

The selection of these rules may be dependent on a number of factors, for example a specific request of an insured party, specific preferences set by an insurance company, issues specific to the location of the insured (i.e. city codes, HOA rules, etc.). Each of these factors may be applied to the submitted data to select the applicable rule sets to apply to the submitted data. For example, the submitted data may contain a metadata tag, or a line item, or some other indicator associating the data with a certain class or characteristic. For example, an inspected property may be a particular type of building, contain a particular type of material, be in a particular location, or be insured by a particular carrier. Any of these associations may correspond to a particular set of rules. By recognizing the indication that the submitted is associated with a certain class or characteristic, the automated system is enabled to select a number of sets of rules from the rules database to access and apply to the data. While some rules may be applied globally, i.e. applied to all portions of the submitted data, other rules may be applied locally, i.e. applied only to a particular line item or a particular subset of the submitted data.

The rule sets may comprise one or more of a building science rule set, materials rule set, and carrier guideline rule set. For example, a building science rule set may comprise processor-executable instructions instructing the automated system to consult a database of building science rules stored on the database. Such rules may include rules regarding construction codes, building structure rules, materials and methods rules, rules regarding building foundation codes, etc. These rules may be stored on a hard drive accessible by the automated system or otherwise accessible by the automated system. These rules may be accessed from a number of sources and may be stored in memory of the automated system and periodically updated to stay up-to-date. A building science rule set may apply to any inspected location wherein mitigation would require construction. Different building science rule sets may be contained in the database and applied to different initial mitigation estimates depending on the type of construction involved.

A number of materials rule sets may be stored in the database. Any initial mitigation estimate may be associated with a number of materials, each requiring the application of an associated number of materials rule sets. These rule sets may be combined and applied to the initial mitigation estimate as a group.

A rule set may be configured specifically for a given insurance carrier, location, loss type, coverage plan, etc. Such a configured rule set enables the automated system to adjust the scope by adding, removing, or otherwise manipulating the line items to include textual notes, quantities, activities, etc., after which the restoration build back estimate is finalized. In embodiments, the configured rule set may be developed based on the actual results of past mitigation and restoration activities. In further embodiments, a rule set may compare the extracted data to stored data from past mitigation and restoration projects, and use actual tasks and costs corresponding to the past mitigation and restoration projects to instruct the automated system to prepare a scope-of-work statement for the damaged structure in question.

A material rules rule set may provide rules regarding costs of the use of particular materials during construction. For example, the raw material cost as well as costs related to installation of such material as well as other consequential costs of using such material. These rules and current cost estimates may be stored in a database accessible by the automated system and updated periodically to stay current.

A carrier guideline rule set may provide rules related to specific insurance carriers. Different insurance carriers may require a number of different rules and preferences related to the costs of mitigation, for example some insurance carriers may have stricter rules related to selecting a construction company or pertaining to particular building codes. An initial mitigation estimate may include a line item associating the inspected property with a particular insurance carrier. The automated system may be operable to detect this association and access the associated carrier guideline rule set from the database to apply to the initial mitigation estimate.

The automated system may determine, according to the received information, a number of applicable rules which must be consulted and applied to the received information to generate an accurate mitigation estimate. According to the applicable rules, the system may access a database of past mitigation, efforts, restoration efforts including data regarding estimates and actual costs of such past efforts. This inspection data and/or the initial estimates may be gathered from estimating companies and other vendors and stored in an organized manner in a database accessible by the server. The database may be automatically updated with each new estimate and mitigation or restoration effort. As new data is input into the database, the amount of data accessible by the automated system will increase, enhancing the accuracy of the estimate generation.

After determining which rules apply to the set of submitted information in step 209, the automated system applies the applicable rule set to the extracted data in step 211. By applying the applicable rules, the automated system is enabled to determine whether, according to the applicable rules, an automated estimate may be generated in step 213. The minimum set of requirements used to determine whether the estimate qualifies for the program may correspond to the particular rule set that has been selected.

The minimum threshold may be a minimum threshold for the amount of data required to generate an accurate scope of work statement. The minimum threshold may be based on a customer-configured level of accuracy for a particular situation, which may be driven by variables such as dollar impact, percentage of accuracy, percentage of dollars, number of activities, level of difficulty extracting additional items, etc. The minimum threshold may be the same for all estimates processed with the method, or it may be dependent on (or established by) the particular rule set used for the method.

If the automated system, at step 213, determines the minimum threshold has not been met, the automated system may use past restoration efforts and mitigation estimates data and use rules to make a number of intelligent decisions. For example, the automated system may map mitigation or restoration line items to their mitigation or reconstruction counterparts, which may be represented in a one-to-many relationship, one-to-none, or a many-to-one relationship.

The automated system may adjust quantities in the mitigation estimate to building-material-specific quantities for reconstruction, or adjust building-material specific quantities for reconstruction to quantities in the mitigation estimate, either of which may involve increasing or decreasing the material quantities or the quantities in the mitigation estimate, and/or using alternative materials.

The automated system may use the applicable rules to define the scope of repair items that do not require reconstruction components, or define the scope of repair items that do not require mitigation components. The automated system may define reconstruction items required that do not have a mitigation counterpart, but rather result from the reconstruction activities themselves. In this way, the automated system may increase the scope of data required to generate an estimate by adding additional fields of required information.

If the system determines that there is insufficient information to generate an automated estimate, then the system identifies what information is lacking and generates questions corresponding to the missing information. This determination may be made by determining whether all information required by the applicable rules has been obtained. For example, if a field of information has not been completed, the automated system may determine such information is still required for an accurate estimate to be generated. If information required by any of the applicable rules has not been obtained, the automated system is operable to generate requests in the form of questions. These questions are then provided, via a user interface, to a file reviewer, who reviews photos, videos, additional documents, metadata, and other available information, and consults subject matter experts if necessary, to gather the needed information. This information is collected and recorded on the system via the user interface, which again evaluates whether there is sufficient data to produce an estimate.

In some embodiments, once the additional data is collected and recorded, it is processed through the applicable rule set (with or without the original data extracted from the received estimate) before the system evaluates whether it has sufficient information to generate an automated estimate. In other embodiments, the system determines whether it has sufficient data to generate an automated estimate after the additional information is collected and recorded, and then processes the additional data (with or without the original data extracted from the received estimate) through the applicable rule set. If, after receiving the additional data, the system determines that there is not enough information to generate an automated estimate, then the system notifies the file reviewer that the automated estimate cannot be generated.

Finally, in step 217, the automated system may identify items for which further information is needed from a system, homeowner, vendor, end user, or another participant. Each of these items may be mapped in step 219 either to a related question that can be understood by a subject matter expert (SME), or, alternatively, to a basic data request that can be completed by a layperson, or that a system can extract automatically from a photo, sketch, or caption. The basic data request, which a layperson can understand and complete, may identify an image, video, document, question, or other data point which may ultimately manifest further needed information relating to the reconstruction scope or to general documentation of the property loss.

These questions and/or data requests are provided to a file reviewer in step 221. The file reviewer may be a SME or some type of insurance worker. Alternatively, the file reviewer may be a secondary computer system which is provided a data request and is operable to extract automatically from a photo, sketch, or caption. In step 223, the file reviewer reviews the photos, information, metadata, and any other documents to gather the required information. At step 225, the file reviewer may send any new information to the automated system, in which the system may optionally first process the new data through the rules in step 211.

Alternatively, after step 225, the system may first determine whether the new data amounts to data sufficient enough to generate an estimate in step 227. If the system determines the new information is enough to generate an estimate, the process moves forward and processes the data through the rules in step 231. Following either step 231 or step 213 (when the automated system determines there is sufficient information to generate an estimate) the process moves to step 215. If, however, the system, in step 227, determines the new information is insufficient to generate an estimate, the process moves to step 229 in which a customer, a mitigation contractor, or desk adjuster, or some other system analyst is notified and works to determine the missing information in step 223.

If an initial estimate is disqualified, such that a repair or mitigation estimate must be generated manually, then embodiments of the system according to the present disclosure can later be leveraged to look at the manually completed mitigation and repair information and to quality check each estimate, or at least expose exception-based quality assurance opportunities based on mapping between the estimates. In some embodiments, a manually completed mitigation estimate can be used to generate an automated reconstruction estimate, or a manually completed reconstruction estimate can be used to generate an automated mitigation estimate. By repeated this process over time, the system may gain intelligence that it can use to make assumptions on future estimates.

Once the minimum threshold is satisfied, and that there is sufficient information to generate an automated estimate, the process proceeds to step 215 in which line items for a scope-of-work statement are generated and configured in the contractor or insurance carrier profile within the system. In this way, the system proceeds to generate the estimate together with corresponding reports and documents. This package of information is then provided, at step 233, to the desk adjuster, carrier agent, or contractor or government entity, etc.

In embodiments, the system can repeat the process of programmatically receiving data from a mitigation estimate; extracting data in a sorted and organized manner for processing; and analyzing the resultant information to make intelligent decisions, based on multiple mitigation estimates being consumed as the process evolves and iterates from one step to the next. At each iteration, the system can predict and recommend a reserve for the claim (reserves are required by state insurance departments, and are associated with funds from premiums being set aside for potential losses to be paid). Having an accurate reserve enables efficient cash flow underwriting, which involves collecting premiums and paying losses while investing premiums to earn a return in investment markets

If the Adjuster submitted collected information and failed to create an initial mitigation estimate, the system may complete an initial mitigation estimate and return this to the adjuster, i.e. intelligently populate data on a job file. The automated system may rate the quality of a mitigation estimate and advise of rules associated with the activities performed by the mitigation vendor/onsite adjuster and thus essentially conduct a retrospective audit.

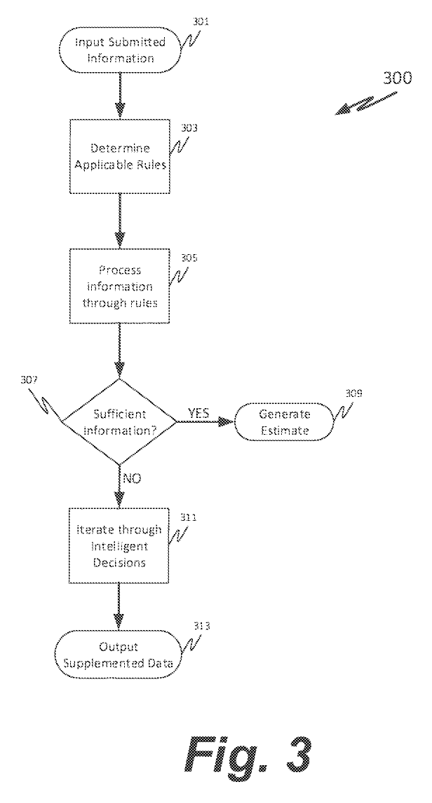

As illustrated in the flowchart of FIG. 3, as submitted information is input into the system 300 (step 301), the system determines applicable rules (step 303). This step may comprise analyzing the submitted information regarding a number of factors, for example the applicable insurance company, particular location rules, particular customer specific rules, etc. After determining the applicable rules (step 303), the system then applies the applicable rules, processing the submitted information through the applicable rules (step 305). This step may comprise deleting extraneous, or irrelevant, information based on a particular applicable rule, or may comprise determining additional information is needed based on a particular applicable rule.

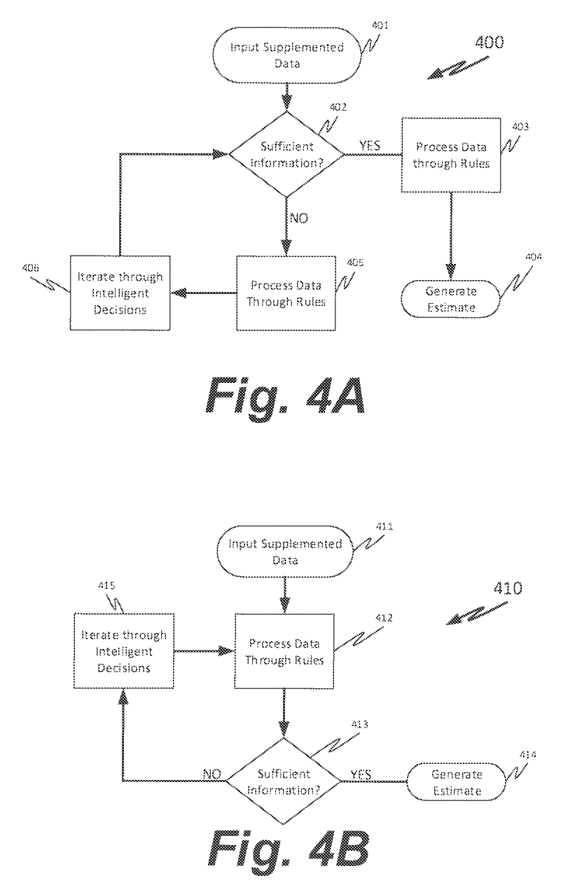

After processing information through the rules (step 305), the system may make a determination of whether the information as currently processed is sufficient to generate an estimate (step 307). If so, the system may proceed to generate an estimate (step 309). If, however, the system determines it lacks the requisite information to generate an estimate in step 307, the system may proceed to make the intelligent decisions, discussed above, to modify and supplement the information (step 311). In this way, the system may access past estimate data and information from a number of databases to determine if additional information may be added to the inputted information to support the estimate generation process. After iterating through one or more of the intelligent decisions, the system should output supplemented data (step 313) at which point the system may proceed with a number of possible methods. Two possible methods which may be utilized in different embodiments are illustrated in FIG. 4A and FIG. 4B.

As illustrated in FIG. 4A, when supplemented data is input into the system 400 in step 401, the system may determine if, having made the intelligent decisions to supplement the data, sufficient information has been gathered to generate an estimate (step 402). If so, the system 400 may process the supplemented data through the applicable rules (step 403) before generating an estimate 404. If, however, the system 400 does not have sufficient information to generate an estimate, the method proceeds to step 405 in which the supplemented data is processed through the rules. After the supplemented data is processed through the rules, the method proceeds to step 406 in which the system iterates through the intelligent decisions using the supplemented data. The method is operable to continue in a loop, processing the data through rules, iterating through intelligent decisions, and determining whether sufficient information has been gathered before finally generating an estimate.

Alternatively, as illustrated in FIG. 4B, when supplemented data is input into the system 410 in step 411, the system may first process the supplemented information through the applicable rules in step 412. At this point, the system may determine if, given the supplemented data as processed through the applicable rules, sufficient information has been gathered to generate an estimate (step 413). If so, the system 410 may proceed to generate an estimate (step 414). If, however, the system 410 does not have sufficient information to generate an estimate, the method proceeds to step 415 in which the system iterates through the intelligent decisions using the supplemented data. The method is operable to continue in a loop, iterating through intelligent decisions, processing the data through rules, and determining whether sufficient information has been gathered before finally generating an estimate.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The systems, methods and protocols illustrated herein can be implemented in hardware and/or software using any known or later developed systems or structures, devices and/or software by those of ordinary skill in the applicable art from the functional description provided herein and with a general basic knowledge of the computer and bioinformatics arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a fingerprint device.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

It is therefore apparent that there has at least been provided systems and methods for reference point independent database filtering. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

As can be seen from the above description, the system and method disclosed herein are useful for automating the process of generating an accurate scope of mitigation and/or repair estimate and supporting documentation. Specific details were given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Persons of ordinary skill in the art will also understand that various embodiments described above may be used in combination with each other without departing from the scope of the present disclosure.

What is claimed is:

1. An estimate automation system, comprising:
an interface;
a processor; and
a memory, the memory storing instructions for causing the processor to:
store in the memory an estimate for mitigation or reconstruction received via the interface;
extract data from the estimate;
make one or more intelligent decisions based on the extracted data; and
generate a scope of work statement.

2. The estimate automation system of claim 1, wherein the interface is a user interface or a communication transceiver.

3. The estimate automation system of claim 1, where the one or more intelligent decisions includes one or more of mapping one or more line items in the estimate to one or more mitigation or reconstruction counterparts; adjusting one or more original quantities in the estimate to one or more building-material-specific quantities for mitigation or reconstruction; defining the scope of one or more repair items that do not require mitigation or reconstruction components; defining one or more mitigation or reconstruction items required that do not have a counterpart; and identifying one or more items for which further information is needed.

4. The estimate automation system of claim 3, wherein mapping one or more line items in the estimate to one or more mitigation or reconstruction counterparts comprises at least one of defining a one-to-many relationship or defining a many-to-one relationship.

5. The estimate automation system of claim 3, wherein adjusting one or more original quantities in the estimate to one or more building-material-specific quantities comprises increasing one or more of the original quantities or identifying an alternative material to associate with at least one of the one or more original quantities.

6. The estimate automation system of claim 3, wherein identifying one or more items for which further information is needed comprises mapping each of the one or more items for which further information is needed to a question that can be understood by a subject matter expert or to a basic data request that can be completed by a layperson.

7. The estimate automation system of claim 6, wherein the basic data request identifies an image, video, or document that may contain the further information.

8. The estimate automation system of claim 6, wherein the memory further stores instructions for causing the processor to repeat the storing, extracting, and making steps until minimum set of requirements has been satisfied.

9. The estimate automation system of claim 3, wherein identifying items for which further information is needed further comprises reporting the items for which further information is needed via the interface.

10. A method of automating scope of work estimates, comprising:
receiving an estimate for mitigation or reconstruction via a communication interface;
storing the estimate in a memory;
extracting data from the estimate using a processor;
storing the extracted data in the memory; and
applying a predetermined rule set to the data stored in the memory, wherein the predetermined rule set is stored in the memory.

11. The method of claim 10, further comprising:
generating a scope of work estimate;
storing the scope of work estimate in the memory; and
outputting the scope of work estimate via the communication interface.

12. The method of claim 10, further comprising:
conducting a preliminary evaluation of whether to proceed with applying the predetermined rule set to the extracted data.

13. The method of claim 10, further comprising:
evaluating whether sufficient data is stored in the memory to generate a scope of work estimate.

14. The method of claim 11, further comprising:
identifying missing data that must be obtained before a scope of work estimate can be generated;
communicating, via the communication interface, a set of questions corresponding to the missing data.

15. The method of claim 14, further comprising:
receiving, via the communication interface, additional data in response to the set of questions;
storing the additional data in the memory; and
repeating the applying and evaluating steps.

16. The method of claim 15, further comprising:
generating, if sufficient data is stored in the memory, a scope of work estimate;
storing the scope of work estimate in the memory; and
outputting the scope of work estimate via the communication interface.

17. A computer program product, comprising:
a non-transitory computer readable storage medium having computer readable program code embodied therewith, the computer readable program code configured when executed by a processor to:
receive an estimate for mitigation or reconstruction via a communication interface;
store the estimate in a memory;
extract data from the estimate using a processor;
store the extracted data in the memory; and
apply a predetermined rule set to the data stored in the memory, wherein the predetermined rule set is stored in the memory.

18. The computer program product of claim 17, wherein the computer readable program code is further configured when executed by a processor to:
generate a scope of work estimate;
store the scope of work estimate in the memory; and
output the scope of work estimate via the communication interface.

19. The computer program product of claim 17, wherein the computer readable program code is further configured when executed by a processor to:
conduct a preliminary evaluation of whether to proceed with applying the predetermined rule set to the extracted data.

20. The computer program product of claim 17, wherein the computer readable program code is further configured when executed by a processor to:
evaluate whether sufficient data is stored in the memory to generate a scope of work estimate.
